(19) United States
(12) Patent Application Publication
(10) Pub. No.: US 2018/0347591 A1
(43) Pub. Date: Dec. 6, 2018

(54) Method and System for Balancing a Mechanical Device by Spinning The Device and Using a Laser

(71) Applicant: International Vibrational Technology, L.L.C., Pleasant Grove, UT (US)

(72) Inventors: Norman Serrano, Pleasant Grove, UT (US); George Field, Pleasant Grove, UT (US); Nathan Godwin, Orem, UT (US); Duane Hall, Pleasant Grove, UT (US)

(73) Assignee: International Vibration Technology, L.L.C., Pleasant Grove, UT (US)

(21) Appl. No.: 16/001,524

(22) Filed: Jun. 6, 2018

Related U.S. Application Data
(60) Provisional application No. 62/516,098, filed on Jun. 6, 2017.

(51) Int. Cl. F04D 29/66; G01M 1/34; B23K 26/08; B23K 26/382

(52) U.S. Cl. CPC F04D 29/662; B23K 26/382; B23K 26/0823; G01M 1/34

(57) ABSTRACT

An apparatus for balancing a fan or other spinning product may comprise a motor for spinning the fan, an accelerometer for gathering sampling data from the fan while it is spinning, a laser source, a laser redirection platform comprising a spinning mirror configured to track the rotational speed of the spinning fan, and a control module. The fan and laser redirection platform may each have an index hole for tracking, using respective photocell transmitters and receivers, rotational speed and phase. The control module may direct the fan motor to spin up the fan, collect balance data, and determine a location on the fan for burning a hole to correct imbalance. The control module may direct the laser redirection platform to spin at the same rpm as the fan, and such that a laser redirection mirror directs a laser beam from the laser source toward the target burn location on the fan. The control module then directs the laser source to emit a laser beam toward the redirection mirror, which directs the laser beam toward the target burn hole location on the fan, where a hole is burned. This process may be repeated iteratively.

### BACKGROUND OF THE INVENTION

Although manufacturing technologies continue to improve, limitations in manufacturing technologies, either in the technology itself, or in the cost of implementing a particular manufacturing technology, result in imperfections in manufactured units. Some imperfections may be acceptable, but some are not. Unacceptable perfections may require post-manufacturing processing, repair, adjustment, or modification.

For some products that are designed to spin or rotate, manufacturing imperfections may result in undesirable imbalance and/or vibration. For such products, the post-manufacturing adjustment may be balancing. In one application, a fan may be formed from a material such as plastic, or a form thereof, or a similar material, many of which are known in the art. The fan may include multiple blades. The fan may be manufactured using an injection molding process or other process or processes known in the art. Because of minor imperfections in the injection mold, or the manufacturing process, or in design, or that result from handling, or from multiple other reasons, the fan may be imperfectly balanced, which may result in vibration, friction, or noise when the fan blades spin or are rotated. The spinning fan may also wear on other parts of a fan housing because of wobble or other results of an imperfectly balanced fan blade.

One approach for balancing a fan blade is to remove material from one or more carefully determined locations on the fan blades or other parts of the fan. For this approach, the fan blades are spun typically up to a particular rpm (revolutions per minute) at which vibration and/or balancing measurements are taken, and material removal parameters are determined. Material removal parameters may comprise a location on the fan for material removal, an amount of material to remove, and a possible shape for material removal. Of course, instead of or in addition to removing material, material may also be added, e.g., using an adhesive, mechanical means, chemical means. Once the location for material removal has been identified, the fan blades may be spun down to be stopped or stationary. At this point, material may be removed from the fan using a punch, e.g., by punching one or more holes in a fan blade. In one example, material may be removed from a plastic fan using a punch that makes a ¼″ inch hole in a specific fan blade at a specific location.

After material has been removed, the fan blade is spun up again to re-check balance, vibration, and/or other characteristics by taking vibration/balancing measurements. If the measurements do not meet applicable standards, additional material removal parameters are determined, the fan is spun down, and material is again removed as described above. The balancing/remediation process thus proceeds iteratively until it is determined that the fan's balance metrics are within allowed tolerances.

This process is inefficient for several reasons. First, it requires repeated spin up and spin down, which takes time. Per-unit processing time is of the essence when hundreds, thousands, or millions of units are being manufactured. Second, this process requires a mechanical machine or system to punch out material on the fan blade.

What is needed is a method and system for balancing and/or decreasing vibration of a fan or other rotating item with improved efficiency.

### BRIEF SUMMARY OF THE INVENTION

A method and system for improved balancing and/or decreasing vibration of a spinning apparatus, or of otherwise correcting or adjusting a spinning apparatus, is disclosed. The system may hereinafter be referred to as a “balancing apparatus.” The associated method may hereinafter be referred to as a “balancing method.”

In one embodiment, a balancing apparatus may comprise a laser source, a laser redirection platform, a motor for spinning the laser redirection platform, and a control module. The laser redirection platform may comprise a redirection mirror, a lens, and a hollow shaft for a laser beam to pass from the laser source to the redirection mirror. The redirection mirror may be oriented to direct a laser beam toward a location on a fan. The lens focus a laser beam from the laser source on the fan.

The laser redirection platform may further comprise an index hole and a photocell transmitter and receiver to detect when the index hole passes between the photocell transmitter and receiver while the laser redirection platform is spinning, and to transmit a corresponding signal to the control module. Using signals received from the photocell receiver, the control module is able to determine rotational speed and angle/phase offset of the laser redirection platform.

A fan may comprise an internal or external motor. The fan may comprise an index hole. The fan may be secured such that it rotates around the same virtual axis as the laser redirection platform. A second pair of a photocell transmitter and receiver may be positioned to detect when the fan index hole passes between the second transmitter and receiver while the fan is spinning. A 3-axis accelerometer may be mechanically secured to the fan or to a fan housing, and may transmit data to the control module.

The control module may direct the fan motor to spin up the fan. While spinning, the control module may process data received from the accelerometer to determine whether the fan is imbalanced and, if so, where to burn one or more holes to address the imbalance.

To burn a hole at a particular location in the fan, without spinning down the fan, the control module directs the laser redirection motor to spin up the laser redirection platform to the same rotational speed (rpm) as the fan, and to then slightly speed up or slow down so that the redirection mirror is oriented to direct a laser beam from the laser source toward a target burn location on the fan. The control module may then direct the laser source to emit a laser energy for a sufficiently long period, i.e., “dwell time,” to burn a hold in the fan.

After one or more holes are burned in the fan, the balancing process may be repeated iteratively until the control module determines that the fan's balance characteristics satisfy certain balance requirements.

### BRIEF DESCRIPTION OF THE DRAWINGS

FIG. 1 shows a side view of an exemplary balancing apparatus.

FIG. 2 shows a perspective angle view of an exemplary balancing apparatus.

FIG. 3 shows a close-up elevated perspective view of an exemplary laser redirection platform.

FIG. 4 shows a slightly elevated perspective view of an exemplary laser redirection platform.

FIG. 5 shows an elevated side view of an exemplary balancing apparatus.

FIG. 6 shows a conceptual view of the components of an exemplary balancing apparatus and control module.

FIG. 7 shows a flowchart of a method for using an exemplary balancing apparatus to balance a fan.

### DETAILED DESCRIPTION OF THE INVENTION

This Application claims priority to U.S. Provisional Application No. 62/516,098, titled “METHOD AND SYSTEM FOR BALANCING A MECHANICAL DEVICE BY SPINNING THE DEVICE AND USING A LASER,” filed on Jun. 6, 2017, the first inventor of which is Norman Serrano, and which is incorporated herein by reference in its entirety.

A method and system for improved balancing and/or decreasing vibration of a spinning apparatus, or of otherwise correcting or adjusting a spinning apparatus, is disclosed. The system may hereinafter be referred to as a “balancing apparatus.” The associated method may hereinafter be referred to as a “balancing method.”

### Table of Reference Numbers from Drawings

The following table is for convenience only, and should not be construed to supersede any potentially inconsistent disclosure herein.

| Reference | |
|---|---|
| Number | Description |
| 100 | balancing apparatus |
| 105 | laser source |
| 110 | laser redirection chassis |
| 115 | laser redirection platform |
| 121a | bottom face of laser redirection platform |
| 121b | top face of laser redirection platform |
| 122 | aperture in laser redirection platform for laser passage |
| 127 | index hole for revolutions of laser redirection platform |
| 144 | redirection mirror |
| 148 | lens |
| 150 | laser beam |
| 160 | fan |
| 162 | fan lip |
| 168 | fan index hole |
| 170 | laser redirection platform motor |
| 173a | rod |
| 173b | spool pulley |
| 174 | belt |
| 175a | hollow rod |
| 175b | spool pulley |
| 184a-b | photocell transmitter and receiver pair for laser redirection |
| | platform index hole 127 |
| 190a-b | photocell transmitter and receiver pair for fan index hole |
| | 168 |
| 200 | control module |
| 202 | connection for accelerometer signals |
| 203 | connection for fan motor control signals |
| 204 | connection for laser source control signals |
| 206 | connection for laser redirection platform motor control |
| 208 | connection for laser redirection platform brake control |
| 210 | connection for signals from diode transistor pairs 182 and |
| | 184 |
| 212 | connection for signals from photo detector 190 |
| 216 | communication connection between control module 200 |
| | and sensor data processing module 320 |
| 305 | accelerometer in vibration sensing module |
| 320 | sensor data processing module |
| 400 | method for balancing a fan using balancing apparatus 100 |
| 405 | step for calibrating balancing apparatus |
| 410 | step for securing fan |
| 415 | step for spinning up fan |
| 420 | step for collecting balance/vibration data |
| 425 | step for processing balance/vibration data to determine |
| | material removal parameters |
| 427 | step for determining whether material removal is |
| | necessary |
| 430 | step for spinning up laser redirection platform |
| 435 | step for applying laser for material removal |
| 440 | step signifying that balancing is complete |

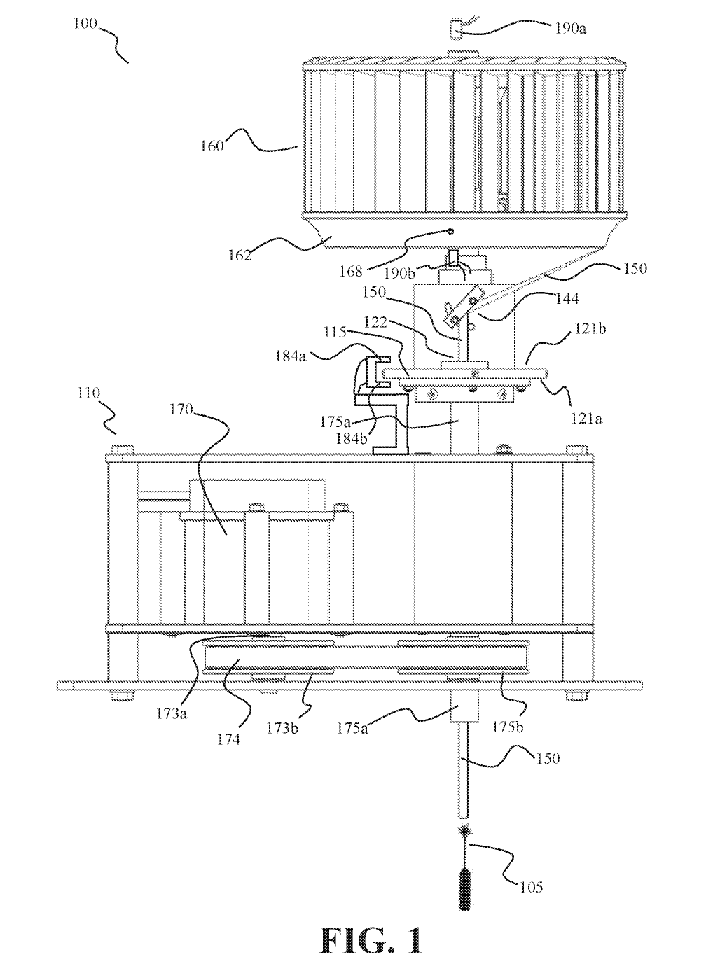

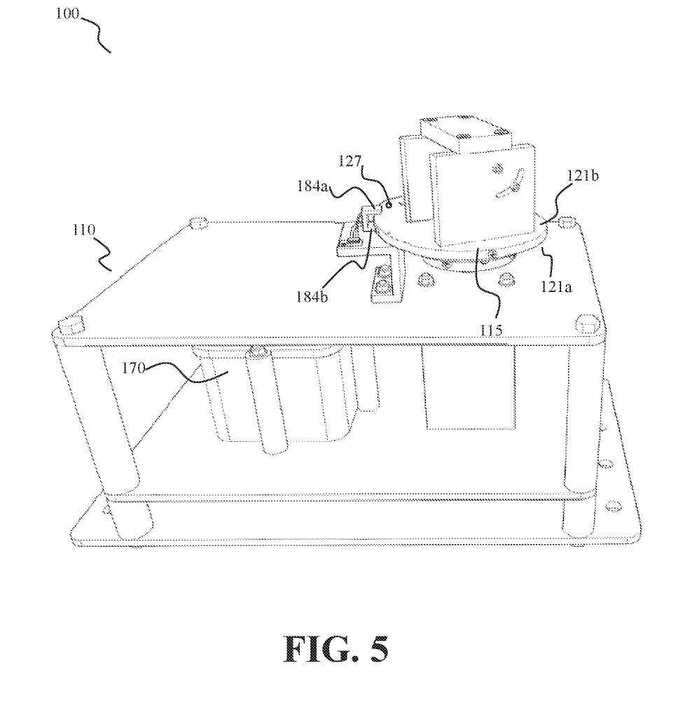

In a preferred embodiment, a balancing apparatus may be configured as illustrated in FIGS. 1-7.

Referring to FIGS. 1-2, 5-6, balancing apparatus 100 comprises several components. In an exemplary embodiment, balancing apparatus may be for balancing automotive fans, e.g., those used in automotive heating and air conditioning systems. Such fans may be approximately 2.0-20.0 inches in diameter and may have approximately 24 fan blades. A person of ordinary skill will recognize that the invention disclosed herein scales and may otherwise be applied without undue difficulty to applications for larger or smaller fans, or to fans with different features or characteristics, or to spinning devices other than fans that may be used for many applications in many industries.

Laser source 105 may be any laser source that is able to remove material from a target object by, e.g., focusing on the location for material removal on the target object. A person of ordinary skill in the art will recognize that many different types of laser sources are widely available and may be used as laser source 105. Exemplary laser sources may include, but are not limited to, gas lasers, crystal lasers, and fiber lasers. A person of ordinary skill in the art will recognize that laser source 105 may be selected based on the characteristics of a particular application, e.g., power requirements, etc. In one embodiment, the laser source may be a CO2 100-Watt laser. A person of ordinary skill will further appreciate that, in addition to power, laser frequency and other laser characteristics may affect selection of a laser for a particular application.

Laser source 105 may be secured in a fixed position relative to the remainder of balancing apparatus 100. Although it may be possible to implement the balancing apparatus in a manner such that laser source 105 is not fixed, but instead spins, such an implementation adds several layers of complexity. First, because laser source 105 must be powered, wiring for power from a power source to laser source 105 will be difficult unless a battery(-ies) or rotating wiring solution is developed to power laser source 105. Several difficulties may arise with a spinning battery-powered laser source: the batter(-ies) may not provide sufficient power; the battery(-ies) may not provide consistent power; the battery(-ies) must be replaced; and the shape and weight distribution properties of the battery(-ies) may make consistent and balanced spinning difficult. Second, laser source 105 must be manufactured to tight tolerances to ensure that it is straight and balanced so that its laser output is predictable and dependable while spinning at high rpm. Third, laser source 105 must be built to withstand the forces and other physical phenomena associated with spinning at high rpm. In general, a fixed-position laser source 105 is likely preferable, although a spinning or other laser source may be feasible with proper design, manufacturing, and engineering.

Balancing apparatus comprises several principle components, including laser redirection platform 115 and fan housing 130.

Laser redirection platform 115 may be made from aluminum, steel, titanium, plastic or any other material or combination of materials known in the art which is stable and which may spin well and which may be used for securing other components, as is described herein below. In one embodiment, laser redirection platform 115 may be circular, with a diameter of 4.0 inches, and may be 0.25-0.375 inches thick.

As will be appreciated by a person of ordinary skill, laser redirection platform 115 may be shaped other than as a circle, although other shapes may present problems with spinning and balance when laser redirection platform 115 spins as described herein.

As shown in FIGS. 1-5, laser redirection platform 115 may have an aperture 122 in its center for passage of laser beam 150 from laser source 105, through laser redirection platform 115, to redirection mirror 144. In a preferred embodiment aperture 122 is circularly shaped and is in the center of laser redirection platform 115. Aperture 122 may be any shape and size, and may be located anywhere in laser redirection platform 115 as long as aperture 122 allows laser beam 150 to travel laser source 105, which may be positioned under laser redirection platform 115, to redirection mirror 144. In a preferred embodiment aperture 122 may be shaped, sized, and located such that aperture 122 provides a passage for laser beam 150 along the virtual axis around which laser redirection platform 115 is configured to spin as described herein. Further, in a preferred embodiment, aperture 122 allows for passage of laser beam 150 at all angular rotation positions of laser redirection platform 115 around the virtual axis, i.e., laser beam is not blocked or obstructed as laser redirection platform 115 spins around the virtual axis as described herein.

As shown in FIGS. 1, 2, and 4, aperture 122 may be located in the center of circular laser redirection platform 115, i.e., the center of circular aperture 122 is on the virtual axis, which may be perpendicular to the faces 121a and 121b of laser redirection platform 115.

Balancing apparatus 100 may also include redirection mirror 144. Redirection mirror 144 may be any material known in the art that reflects and/or otherwise redirects laser energy. In one embodiment, redirection mirror 144 may be a mirror.

In general, and as shown in FIGS. 1, 2, and 5, laser source 105 is configured to emit laser beam 150 through aperture 122, such that laser beam 150 is perpendicular to the planar surfaces of 121a and 121b of laser redirection platform 115 as it passes through aperture 122.

In one embodiment, aperture 122 may comprise a lens 148 configured to focus laser beam 150 at or near fan 160, as described herein below. A person of ordinary skill in the art will appreciate that lens 148 may be selected based on laser characteristics, the distance that laser beam 150 travels from lens 140 to fan 160, and other features of fan 160 and apparatus 100.

Redirection mirror 144 is secured to laser redirection platform 115 and is configured and angled to direct laser beam 150 toward fan 160. The orientation of redirection mirror 144 may be adjustable in three dimensions, i.e., in the x, y, and z axis. In a preferred embodiment, the orientation of mirror 144 is continuously adjustable in all three dimensions.

In one embodiment, the surface of redirection mirror 144 may be planar, i.e., flat. In other embodiments, the surface of redirection mirror 144 may be curved, e.g., a concave surface.

Redirection mirror 144 may be configured to direct laser beam 150 toward any part of fan 160. Redirection mirror 144 may be configured to direct laser beam 150 at any angle relative to laser redirection platform 115.

Lens 148 may be secured in a fixed position relative to redirection mirror 144. Laser lens system 148 may be configured to focus laser beam 150, as directed from redirection mirror 144, on or near fan 160. As discussed herein below, lens 148 may be configured to focus laser beam 150 onto a point on lip 162 of fan 160.

Redirection mirror 144, and any other mirrors disclosed or referenced herein, may comprise adjusting mechanism to adjust the tilt of mirror so that the path of laser beam 150 may be calibrated and/or otherwise adjusted. For example, as is known in the art, redirection mirrors 144 may include threaded continuous adjustors for adjusting the tilt angle of redirection mirror 144 in any of the x-, y-, and/or z-dimensions.

In one embodiment, fan 160 may have a lip 162 that tracks the circumference of fan 160. This lip 162 may protrude from the bottom of fan 160. Redirection mirror 144 may be secured, oriented, and adjusted to direct laser beam 150 toward lip 162.

A person of ordinary skill will appreciate that laser beam 150 may engage fan 160 at many different angles. The angle at which laser beam 150 engages fan 160 may affect the burn rate of fan material, the amount of material removed from fan 160, the power or energy of laser beam 150 used to burn off material from fan 160, and collateral damage/burn. Collateral damage/burn may result where laser beam 150 burns all the way through fan 160, thereby creating a hole. If laser beam 150 exits through the burned hole, laser beam 150 may engage other material or items, e.g., fan housing 130, other equipment, people, etc. In general, collateral damage/burn is undesirable, and may be mitigated and/or avoided by directing laser beam 150 toward a laser absorption material or other safe engagement area for laser beam 150. For example, a layer of plastic may be placed in the path of laser beam 150, but behind fan 160 (behind from the perspective of laser source 105) and this plastic layer may be sufficiently thick to act as a burn/absorption layer for laser beam 150 when it exits out of a hole burned by laser beam 150 (or out of any other hole in fan 160) in fan 160.

In a preferred embodiment, a fan housing may include a fan motor and an engagement mechanism through which the fan motor may mechanically engage and spin fan 160. The fan motor may engage fan 160 mechanically through an aperture in the center of the fan. A fastener may be used to hold fan 160 in place when mechanically engaged with the fan motor. For example, the drive shaft of the fan motor may be in a D-shape or a D-profile, i.e., where one side of the motor drive shaft is flat and the opposite side is curved, thereby forming a “D” shape. Fan 160 may have a complementary-shaped aperture in its center so that the fan motor engages fan 160 when the aperture in fan 160 slips over the motor shaft in the fan motor. In this manner, because of the D-shaped aperture in fan 160 and the motor shaft in the fan motor are mechanically interlocked. Many other mechanical engagement types and solutions are known in the art, including but not limited to nuts, keyed shafts, splines, threaded engagement, and compression. Other fastener types may include, but are not limited to, retaining rings, caps, pins, and set screws.

In another embodiment, fan 160 may be part of fan 160 component 159 that comprises a fan 160 and a fan motor in the same unit. In this embodiment, fan 160 may be engaged and powered by simply providing power to fan 160, or by providing power and one or more control signals to fan 160.

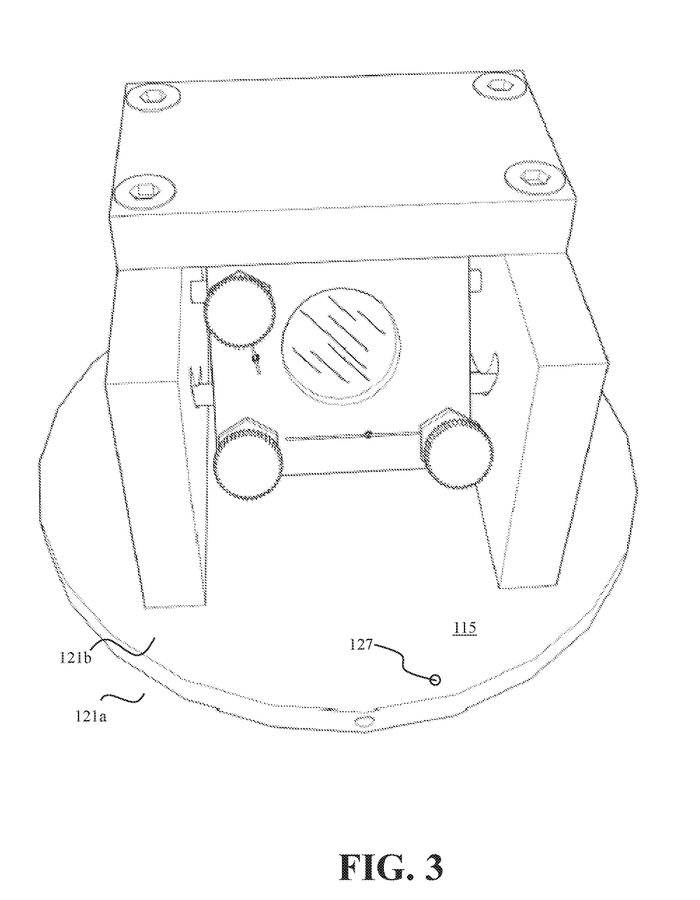

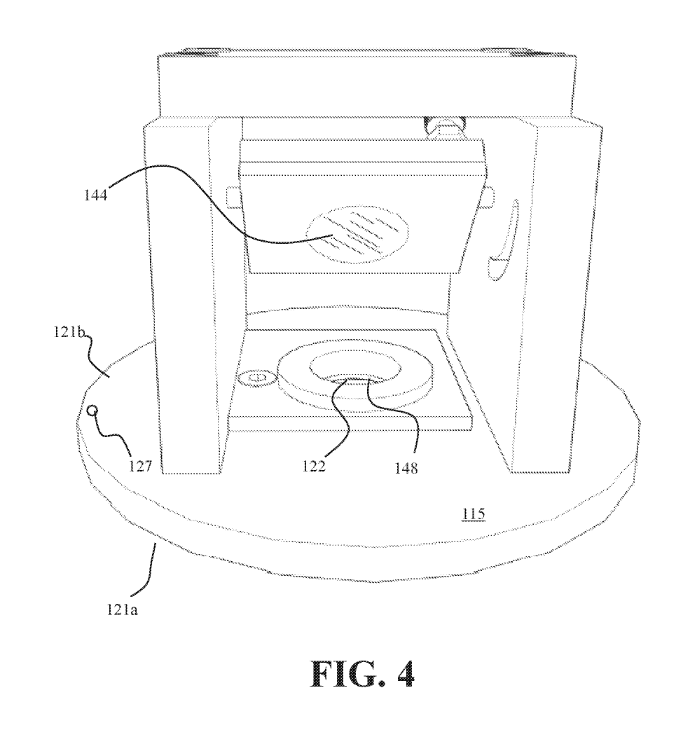

As shown in FIGS. 3 and 4, laser redirection platform 115 may additionally include an index marker, which may be index hole 127. In a preferred embodiment, index hole 127 may be a small hole near the edge of laser redirection platform 115. In general, index hole 127 may be positioned at any location on laser redirection platform 115, but a location near the edge of laser redirection platform 115 may be more amenable to a detecting index hole 127 as laser redirection platform 127 spins. In other embodiments, index hole 127 may be an effective hole, e.g., a translucent material through which some type of light may be able to pass. A person of ordinary skill in the art will appreciate that many different techniques may be used for an index marker on laser redirection platform 127, and that many approaches could be implemented to track and/or sense revolutions or cycles of spinning laser redirection platform 115.

In a preferred embodiment, hole 127 may be aligned to be directly beneath laser beam 150, i.e., directly beneath virtual path of laser beam 150. In general, hole 127 may be located at any angular position on laser redirection platform 115, and at any angular location relative to the path of laser beam 150 (as directed by redirection mirror 144) because the control system, as described below, may be preprogrammed with the angular location of hole 127 relative to laser beam 150.

For example, instead of using holes as described herein, to track rotational speed and cycles/revolutions of laser redirection platform 115, encoders (e.g., electrical, optical, magnetic, etc.) could be used.

Balancing apparatus 100 may include laser redirection platform motor 170 for spinning laser redirection platform 115. Laser redirection platform motor 170 is shown at least in FIGS. 1, 2, and 5.

In one embodiment, motor 170 may be configured as shown in FIGS. 1, 2, and 5 using rod 173a, spool pulley 173b, belt 174, hollow rod 175a, and spool pulley 175b. In this embodiment, motor 170 may spin rod 173a, which may be fixed to spool pulley 173b such that spool pulley 173b spins/rotates with rod 173a. The rotation of spool pulley 173b drives belt 174, which in turn drives, spool pulley 175b, which is fixed to hollow rod 175a. Hollow rod 175a is fixed to laser redirection platform 115, and thereby spins/rotates laser redirection platform 115 when motor 170 spins and thereby rotates rod 173a. In a slightly alternate embodiment, hollow rod 175a may not be fixed to laser redirection platform 115, and spool pulley 175b may be fixed to a bracket, which may be fixed to laser redirection platform 115. In one exemplary embodiment motor 170 may be a brushless DC motor, a brushed DC motor, or an AC motor. A person of ordinary skill will appreciate that many different types of motors and drive configurations may be aptly substituted.

Motor 170 may be powered by any one of numerous power supply methods for a motor as are known in the art.

Motor 170 may include control connections 171 and 172, which may employ any motor control and/or connection technology known in the art, e.g., hard wire, wireless, or any other technology known in the art.

Control connection 171 may be a motor control for increasing power to motor 170, or otherwise controlling the speed of motor 170. In a preferred embodiment, the motor will have sufficient power and other characteristics to spin laser redirection platform 115 at up to 3,000 rpm (revolutions per minute), or possibly higher in particular applications and/or possibly using a motor with different characteristics. The motor power may be continuously controllable so that power to the motor and resulting laser redirection platform rpm are continuously adjustable. A person of ordinary skill will recognize that the size and power of motor 170, as well as minimum and maximum rpm and other characteristics, may be varied depending on particular applications and configurations.

Control connection 172 may be a brake control for slowing the angular speed, e.g., rpm, of laser redirection platform 115. In a preferred embodiment, brake control 172 is connected to and configured to control a motor braking system 210. The motor braking system, which may be internal or external, and may be integrated into motor 170 or may be an add-on component for motor 170. The motor braking system may be friction-based, mechanical, coil inductive loop, or any other braking systems, many of which are known in the art and are within the knowledge and understanding of a person of ordinary skill in the art.

In some embodiments, balancing apparatus 100 may not include a motor braking system.

As shown in FIGS. 1, 2, and 5, balancing apparatus 100 may include photocell transmitter and receiver pair 184, which may be secured in a fixed location relative to spinning laser redirection platform 115, e.g., secured to laser redirection chassis 110, or to a motor fan chassis, or to any other structure or component such that its location is fixed relative to spinning laser redirection platform 115. Photocell pair 184, comprising transmitter 184a and receiver 184b, where 184a is above laser redirection platform 115 and 184b is below laser redirection platform, are secured to be directly above and beneath, respectively, laser redirection platform index hole 127 such that, as laser redirection platform 115 spins, index hole 127 passes between photocell transmitter 184a and photocell transmitter 184b.

Photocell pair 184 is fixed in location such that it does not touch, come in physical contact with, or otherwise obstruct, laser redirection platform 115 while laser redirection platform 115 is spinning.

In one embodiment, photocell pair 184 may use infrared energy.

In alternate embodiments, a system for tracking rotational speed, and rotational angle (i.e., phase) of laser redirection platform 115, while laser redirection platform 115 is spinning, may come in contact with laser redirection platform 115, or any part that spins with laser redirection platform 115. For example, laser redirection platform 115 may be in contact with and spin one or more wheels of a known circumference, and balancing apparatus 100 may count full and partial revolutions of such wheel(s). Although approaches employing contact for tracking rotational speed and angle of laser redirection platform 115 may be used, such approaches may be difficult because the contact between laser redirection platform 115 (and/or one or more parts that spin with laser redirection platform 115) may affect balance and/or rotational speed of laser redirection platform 115.

Photocell pair 184 may comprise transmitter 184a and receiver 184b, or vice versa. Transmitter 184a is oriented so that it emits energy toward receiver 184b. When index hole 127 passes between transmitter photocell transmitter 184a and receiver 184b, the path between transmitter 184a and receiver 184b is unobstructed such that receiver 184b detects the light or energy emitted by transmitter 184a, and may transmit a corresponding signal to control module 200 (described herein below).

A person of skill in the art will appreciate that pair 184 may employ many types of technologies for emitting a signal and/or energy and sensing or detecting the emitted signal and/or energy, including but not limited to laser, infrared, ultraviolet, visible, and any other type of detectable light or energy known in the art.

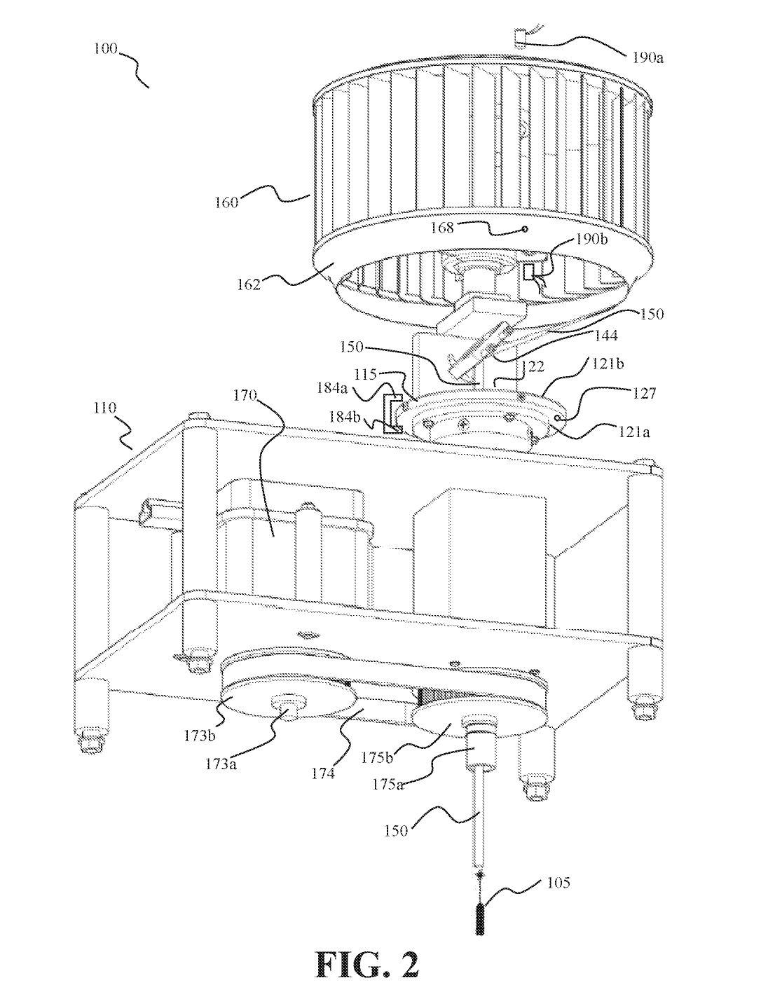

As shown in FIGS. 1 and 2, fan 160 may include a fan index marker, e.g., a fan index hole 168. In other embodiments, the fan index marker may be a painted dot, or a small mechanically secured marker, or a protrusion or extrusion from manufacturing, or an effective hole, or any other solution known in the art for sensing and/or detecting a particular angle/phase on fan 160 while fan 160 is spinning. In one embodiment, fan index hole 168 may be located along fan lip 162. Fan index hole 168 may be a hole in fan 160 through which light is directed, e.g., laser light or infrared light, and which may be detected by a receiver on the opposite side of fan index hole 168 as fan index hole 168 passes an emitter/receiver pair when fan 160 is spinning.

For example, as shown in FIGS. 1 and 2, photocell transmitter 190a may be secured above fan 160 and photocell receiver may be secured below fan 160 such that, when fan 160 is spinning and fan index hole 168 passes between transmitter 190a and receiver 190b, the light from transmitter 190b reaches and is therefore detected by receiver 190b, which may transmit a signal to control module 200. In one embodiment, green light may be used because other energy frequencies may pass through the material of fan 160. In general, the type of energy or detecting solution used may depend on the material of which fan 160 is made, and on other variables and characteristics of particular applications.

A person of ordinary skill will appreciate that other schemes, systems, technologies and/or approaches may be used to identify an index position, rotational speed, and/or rotational angle/phase of fan 160 while fan 160 spinning.

Photocell transmitter 190a and photocell receiver 190b may be mounted and/or secured in any manner such that these components are stationary relative to rotation of fan 160.

Fan 160 may further include a motor for fan 130, a power connection for powering the fan motor, and control connection 132 for controlling power and/or speed of fan 160.

Balancing apparatus 100 further includes a control module 200 for controlling fan motor 165, laser redirection platform motor 170, laser source 105, and for receiving data from photocell receiver 184b and photocell receiver 190b, and for performing other control functions. Connection 203 is the connection for sending and/or receiving signals to control fan motor 165. Connection 204 is for sending and/or receiving signals to control the laser source. Connection 206 is for sending and/or receiving signals to control power to laser redirection platform motor 170. Connection 208 is for sending and/or receiving signals to control the brake on laser redirection platform motor 170. Connection 210 is for receiving signals from photocell receiver 184b. Connection 212 is for receiving signals from photocell receiver 190b.

As will be appreciated by one of ordinary skill in the art, control module 200 may comprise one or more components, and may include components entirely or partially in software and/or hardware. In one embodiment, control module 200 may comprise a computer or mini-computer with a processor, memory, non-volatile storage, and interfaces for receiving, sending, and processing signals on connections 203, 204, 206, 208, 210, and 212.

Balancing apparatus 100 may also include a vibration sensing module comprising, e.g., 3-axis accelerometer 305. In one embodiment, 3-axis accelerometer may be secured to fan 160 to detect vibrations, e.g., by securing 3-axis accelerometer to a non-spinning mounting point on fan 160 or the associated fan housing or chassis. A person of ordinary skill in the art will appreciate that accelerometer data for fan 160 may be collected in various ways. Accelerometer 305 may transmit accelerometer data to control module 200 over connection 202.

Control module 200 may include computer instructions to determine, based at least in part the sampled and received vibration data, material removal parameters (e.g., location of holes, size of holes, number of holes) for burning holes in fan 160. The location of a hole to be burned may comprise an angle/phase offset from fan index hole 168. By comparing the time stamps on received vibration sampling data with the time stamps for fan index hole 168, and further by knowing or having stored the fixed location of photocell receiver 190b, and possibly accelerometer 305, sensor data processing module 320 is able to determine material removal parameters for fan 160.

In one embodiment, receiver 184b and receiver 194b may be aligned, i.e., the detectors for laser redirection platform index hole 127 and fan index hole 168 may be positioned at the same angular offset (e.g., phase). In an alternate embodiment, receiver 184b and receiver 190b may be positioned at a known angular/phase offset from each. Either way, control module 200 may stores and/or have access to the angular offset between receiver 184b (for laser platform index hole 127) and receiver 190b (for fan index hole 168). Control module 200 may use this angular/phase offset to align laser beam 150 with location burning a hole in fan 160 based on material removal parameters.

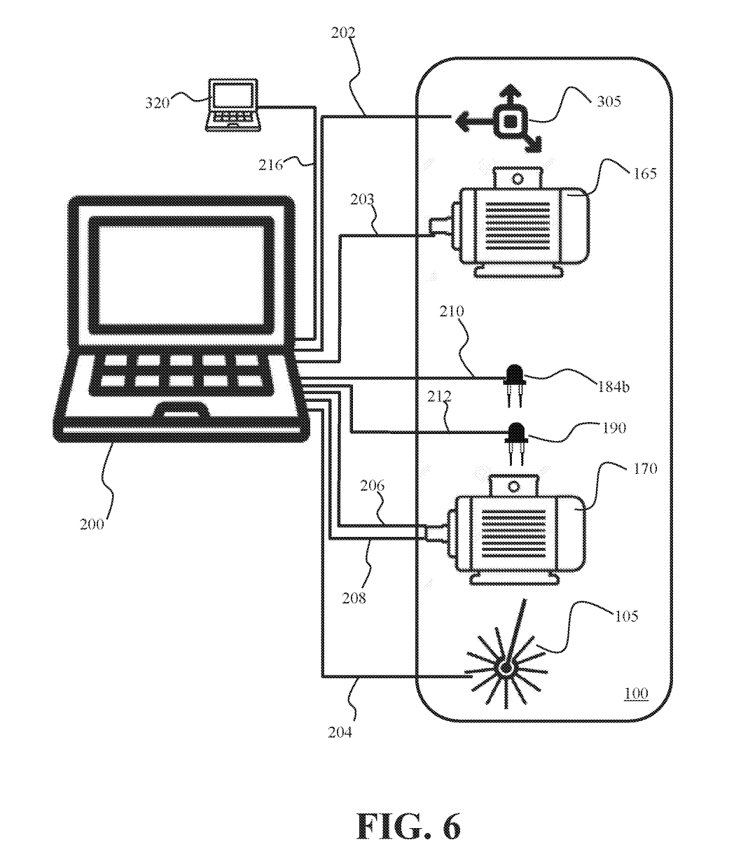

FIG. 6 shows a conceptual organization of the components of balancing apparatus 100 as described as described herein. A person of ordinary skill in the art will appreciate that many modifications and variations of the implementation of the conceptual organization shown in FIG. 6 are within the scope and spirit of the disclosure herein.

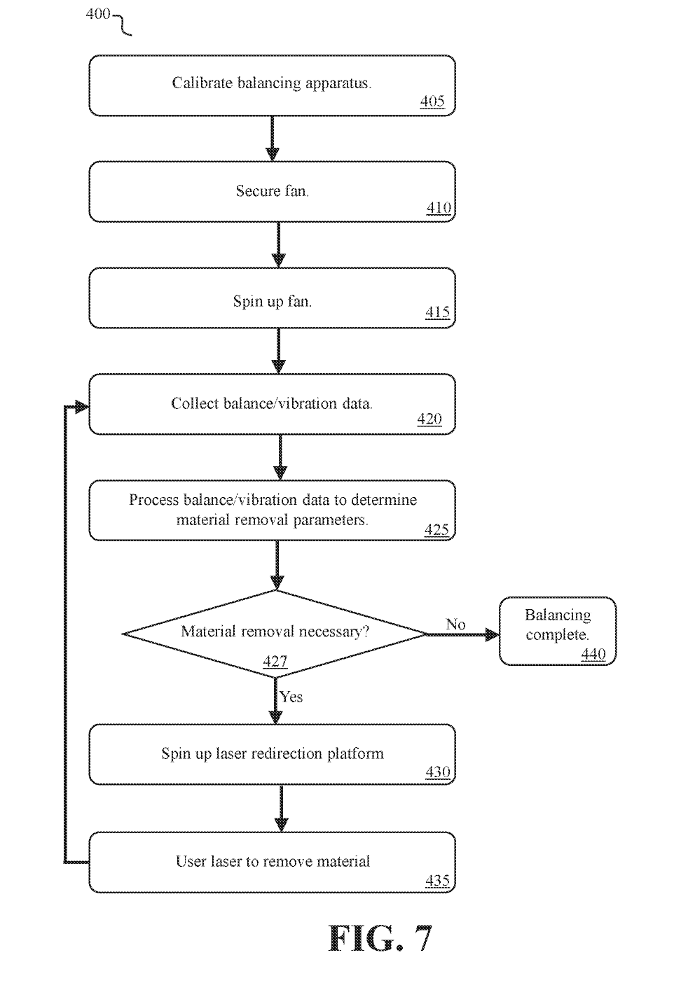

FIG. 7 shows a flowchart for an exemplary method for balancing a fan using balancing apparatus 100.

At step 405, balancing apparatus 100 may be calibrated. Calibrating may comprise at least adjusting the position and/or angle of mirrors so that lasers and/or other lights used in balancing apparatus 100 are directed to the correct locations, e.g., toward a desired burn location on fan 160, or toward index hole 127, or toward fan index hole 168. Calibrating may further comprise adjusting or replacing lens 148 so that laser beam 150 focuses at a desired distance from mirror 146, e.g., at fan 160. Calibrating may also comprise adjusting laser source 105 so that laser beam 150 is accurately directed toward redirection mirror 144.

At step 410, a fan 160 may be secured for balancing by aligning the rotational axis of fan 160 with the rotational axis of laser redirection platform 115, such that fan 160 is above laser redirection platform 115. In one embodiment, fan 160 may include a fan housing and/or fan motor.

At step 415, control module 200 may transmit a signal over connection 203 to fan motor 165 directing fan motor 165 to spin fan 160 at a constant rpm. The particular angular speed, e.g., rpm, at which fan 160 spins depends on the particular application and fan characteristics including but not limited to fan weight, type, and size, and other characteristics of balancing apparatus 100. In general, balance defects are more pronounced and easier to detect at higher rpm, but this is merely a general rule of thumb and may not apply for particular applications, particular characteristics of the fan or balance apparatus 100, or other, e.g., non-balancing, applications. In one embodiment, fan motor 165 may spin at approximately 3,000 rpm. As fan 160 spins, control module 200 receives signals from sync mark detector 190, which sends a signal every time fan sync mark 168 passes sync mark detector 190. By timestamping these signals, control module 200 is able to compute the rotational speed of fan 160, as well as the angular/phase offset of fan 160.

At step 420, accelerometer 305 collects and timestamps vibration sensing data and transmits such collected data to control module 200.

At step 425, control module 200 provides collected vibration sensing data to sensor data processing module 320 over connection 216. Sensor data processing module 320 processes received vibration sensing data to determine whether fan 160 meets balance/vibration standards and, if not, to determine material removal parameters for burning one or more holes in fan 160. Sensor data transmits processed output data, which may include material removal parameters, to control module 200 over connection 216.

At decision step 427, if control module 200 determines that fan 160 is sufficiently balanced, that the vibrations are sufficiently small, or that some other test or threshold is satisfied, then processing may proceed to completion state 440, and control module 200 may direct fan motor 165 to cease spinning, or to allow fan 160 to spin down.

At decision step 427, if control module 200 determines that fan 160 does not meet balance/vibration standards, then method 400 proceeds to step 430.

In one embodiment, material removal parameters may comprise a location on fan 160 for burning a hole. This location may be identified as an angular/phase offset from fan index hole 168.

At step 430, control module 200 may spin up laser redirection platform 115 so that it is spinning at the same rpm as fan 160, and also so that the path of laser beam 150 is aligned with burn hole target the angular/phase offset (from fan index hole 168) that identifies the location of the targeted hole to be burned. Control module 200 may determine the rpm at which fan 160 is spinning by using the timestamps on readings from receiver 190b. The time difference between the signals from receiver 190b is the time for one revolution. Control module 200 determines the rpm at which laser redirection platform 115 is spinning by using the timestamped signals from receiver 184b. The time difference between readings is the time for one revolution of laser redirection platform 115.

In conjunction with spinning up laser redirection platform 115 to the same rpm as fan 160, control module may send signals to align the path of laser beam 150 with the computed location on fan 160 for burning a hole. Because control module 200 has access to the fixed angular offset 310 between laser redirection platform index receiver 184b and receiver 190b, and because control module receives signals every time laser redirection platform index hole 127 passes receiver 184b, and every time fan sync mark 168 passes receiver 190b, control module 200 is able to determine how to send signals to laser redirection platform motor 170 to speed up or slow down rotation of laser redirection platform 115 so that both laser redirection platform 115 and fan 160 are spinning at the same rpm, and so that laser path 150 is aligned with the target burn location. The algorithm for speeding up or slowing down rotation of laser redirection platform 115 to match rpms of fan 160 and to align laser path 150 with a target burn location may depend on acceleration and deceleration characteristics of a particular laser redirection platform motor 170 and, more specifically, on such characteristics of laser redirection platform motor 170 as configured and used with laser redirection platform 115 and other features and components as described herein.

In some embodiments, fan motor 165 could be accelerated or decelerated in addition to laser redirection platform motor 170.

In some embodiments, depending on the rpm of fan 160, power of laser source 105, properties (e.g., thickness and burn properties) of material for fan 160, and other features, laser redirection platform 115 may remain stationary, i.e., not rotate, and control module 200 may time one or more pulses from laser source 105 to strike engage a desired burn location on fan 160.

At step 435, control module 200 activates laser source 105 to burn a hole in fan 160 at the desired burn location. The hole may be burned using a burst, or a pulsing pattern, or a solid dwell time, or any other application of laser beam 150 to burn a hole at a target burn location. In some embodiments, control module 200 may direct and control balancing apparatus 100 to burn multiple holes or holes of varying shapes or to burn off material in a manner that does not comprise a hole, e.g., removing material to decrease thickness of fan 160, but not enough to go all the way through fan 160. When hole(s) have been burned, the method may return to step 420 to determine whether fan 160 is sufficiently balanced, vibration has been sufficiently minimized, or other requirements has been met.

Because fan 160 continues to spin when the burn-off of material happens, it is not necessary to re-spin-up fan 160 to re-test for balance. Avoiding a spin-down and spin-up cycle offers an opportunity for gaining significant efficiencies.

When material has been burned from fan 160 at step 435, method 400 returns to step 420. In this manner, a fan or other product may be iteratively balanced.

A person of ordinary skill will appreciate that, in general, the orientation of the disclosed balancing apparatus and components may be varied without departing from the spirit of the invention and disclosure herein, e.g., laser redirection platform 115 may be above fan housing 130, or components could be configured at a 90-degree offset from balancing apparatus 100 as shown in FIGS. 1-5, (e.g., vertical instead of horizontal). In general, the balancing apparatus as disclosed herein is not gravity or orientation dependent.

A person of ordinary skill will further appreciate that the spatial and logical organization of the components of balancing apparatus 100 could be varied without precluding or materially detracting from the effectiveness and/or usefulness of balancing apparatus 100 as disclosed herein, and without departing from the spirit of the invention and disclosure herein. Further, a person of ordinary skill will appreciate that the method steps as disclosed herein could be reordered or otherwise reorganized, and that some steps may be added, omitted, and/or modified with materially departing from the invention and disclosure herein.

What is claimed is:

1. An apparatus for adjusting a product, comprising:
a control module; and
a laser-based material removal module comprising:
a laser source; and
a laser redirection module configured to direct laser energy from the laser source toward the product;
wherein:
the product is configured to spin;
the control module includes instructions that, when executed, cause the control module to:
receive defect data for a product;
transmit the received defect data to a processing module;
receive at least one material removal parameter from the processing module; and
actuate the laser-based material removal module to remove material from the product based on the at least one material removal parameter.

2. The apparatus of claim 1, wherein the product further comprises a rotational index marker.

3. The apparatus of claim 1, wherein the laser redirection module further comprises a reflective surface oriented to direct laser energy from the laser source toward the product.

4. The apparatus of claim 3, wherein the reflective surface is a mirror.

5. The apparatus of claim 1, wherein:
the product further comprises a product rotational index marker; and
the control module further includes instructions that, when executed, cause the control module to:
direct the product to spin;
determine the rotational speed at which the product is spinning;
receive defect data for the product;
transmit the received defect data to a processing module;
receive at least one material removal parameter from the processing module; and
actuate the laser-based material removal module to remove material from the product based on the material removal parameters.

6. The apparatus of claim 1, wherein the at least one material removal parameter is an angular offset from the product rotational index marker;

7. The apparatus of claim 1, wherein the product is a fan.

8. The apparatus of claim 1, wherein actuating the laser-based material removal module to remove material from the product based on the at least one material removal parameter comprises directing the laser-based material removal module to emit laser energy toward the product.

9. The apparatus of claim 5, wherein:
determining the rotational speed at which the product is spinning comprises receiving signals from a photocell receiver when the product rotational index marker passes the photocell receiver.

10. The apparatus of claim 5, wherein:
the laser redirection module is configured to spin.

11. The apparatus of claim 10, wherein the laser redirection module comprises a reflective surface that is oriented to direct energy from the laser source toward the fan.

12. The apparatus of claim 11, wherein the reflective surface is a mirror.

13. The apparatus of claim 10, wherein the instruction for actuating the laser-based material removal module to remove material from the product based on the material removal parameters further comprises an instruction that, when executed, causes the control module to:
direct the laser source to spin at the same rotational speed as the product, at a target rotational offset from the product, based on the material removal parameters; and
direct the laser source to emit energy toward the product sufficient to burn one or more holes in the product.

14. The apparatus of claim 13, wherein:
the laser redirection module further comprises a laser redirection index marker;
the apparatus further comprises a laser redirection photocell transmitter and receiver pair;
the laser redirection photocell transmitter is oriented to emit energy toward the laser redirection photocell receiver;
the laser redirection photocell receiver is secured and oriented to receive light emitted from the laser redirection photocell transmitter, and transmit a signal to the control module, when the laser redirection index marker passes the laser redirection photocell receiver while the laser redirection module is spinning; and
directing the laser source to spin at the same rotational speed as the product, at a rotational offset from the product, based on the material removal parameters comprises:
receiving a signal from the laser redirection photocell receiver;
determining, based on the timing of the signal from the laser redirection photocell receiver and the timing of a signal from product rotational index marker, an angular offset between the laser redirection index marker and the product rotational index marker;
based on the determined angular offset, determining to maintain, increase, or decrease the rotational speed of the laser redirection module to achieve the target rotational offset.

15. The apparatus of claim 1, further comprising a lens to focus laser energy from the laser source.

16. An apparatus for adjusting a product, comprising:
a control module; and
a laser-based material removal module comprising:
a laser source; and
a laser redirection module configured to direct laser energy from the laser source toward the product;
wherein:
the product is configured to spin;
the laser redirection module is configured to spin;
the product comprises a product rotational index marker;
the laser redirection module comprises a mirror oriented to direct laser energy from the laser source toward the product;
the control module includes instructions that, when executed, cause the control module to:
direct the product to spin;
determine the rotational speed at which the product is spinning;
receive defect data for a product;
transmit the received defect data to a processing module;
receive at least one material removal parameter from the processing module, wherein the at least one material removal parameter comprises an angular offset from the product rotational index marker;
direct the laser redirection module to spin at the same rotational speed as the product, at a target angular offset from the product, based on the at least one material removal parameter; and
direct the laser-based material removal module to emit laser energy toward the product to remove material from the product based on the at least one material removal parameter.

17. The apparatus of claim 16, wherein the product is a fan.

18. A method for balancing a product, comprising:
directing a product motor to spin the product;
receiving imbalance data gathered from one or more balance sensors while the product is spinning;
providing the imbalance data to a processing unit;
receiving, from the processing unit, at least one material removal parameter comprising an angular offset from a product index marker on the product;
directing a laser redirection motor to spin a laser redirection module at the same rotational speed as the product, and such that a laser redirection rotational index marker on the laser redirection module is at a fixed angular offset from the product rotational index marker;
directing the laser-based material removal module to emit laser energy toward the product to remove material from the product based on the at least one material removal parameter.

19. The method of claim 18, wherein the product is a fan.
